(19) United States
(12) Patent Application Publication
(10) Pub. No.: US 2003/0223920 A1
(43) Pub. Date: Dec. 4, 2003

(54) Method for repairing catalytic heaters

(76) Inventors: John N. Critchley, Clinton, CT (US); William C. Sterling, Hesperia, CA (US)

Correspondence Address: Barry L. Kelmachter, BACHMAN & LaPOINTE, P.C., Suite 1201, 900 Chapel Street, New Haven, CT, 06510-2802, US

(21) Appl. No.: 10/163,724

(22) Filed: Jun. 4, 2002

(51) Int. Cl. F01N 3/10; B01D 53/34

(52) U.S. Cl. 422/174; 422/177; 422/179; 29/890

(57) ABSTRACT

The present invention relates to a method for repairing and refurbishing catalytic heaters and to a replacement catalyst cartridge used therein. The method broadly comprises the steps of removing a face frame and a face screen from a heater frame of a catalytic heater to be refurbished, removing catalyst material from an interior portion of the heater, providing a replacement catalyst cartridge having a layer of catalyst material, and securing the cartridge to the heater frame. The replacement catalytic cartridge comprises a frame, an upper screen joined to the frame, a lower screen joined to the frame, and a layer of catalyst material positioned between the upper screen and the lower screen. The replacement catalytic cartridge also has a layer of insulation material secured to the cartridge frame, which layer of insulation material forms a gas tight seal with a peripheral lip of the catalytic heater.

### BACKGROUND OF THE INVENTION

The present invention relates to a method for repairing catalytic heaters and a replacement catalyst cartridge used therein.

Catalytic heaters are used in many industrial applications. Typical catalytic heaters have a housing or heater frame, a fuel gas supply system for supplying fuel gas or vapors into the housing, a catalyst material within the housing, and a system for distributing the fuel gas over the cross sectional area of the catalyst. The catalyst typically comprises a thermally-resistant cloth having a plurality of gas passage openings. A catalytically active material such as platinum, rhodium, or palladium is deposited on the thermally-resistant cloth. Some sort of retention device secures the supported catalyst in the housing.

While the catalyst in the catalytic heater is not consumed over time, it can become clogged with inert materials that reduce its efficiency and heat output. While catalytic heaters in this condition can be repaired, many companies are reluctant to service the heaters due to the downtime normally involved. The only options available to these companies were to (1) send back entire catalytic heaters to manufacturers for refurbishment, (2) purchase spare catalytic heaters to substitute for those being repaired or (3) rebuild the catalytic heaters on-site. In the past, these options have not been desirable because of the expense and lost production time involved.

### SUMMARY OF THE INVENTION

Accordingly, it is an object of the present invention to provide a method for repairing and refurbishing catalytic heaters on site.

It is a further object of the present invention to provide a method as above which is economically beneficial and does not result in undue lost production time.

It is yet a further object of the present invention to provide a replacement catalyst cartridge for use in the repair method.

The foregoing objects are attained by the repair method and the replacement (and replaceable) catalyst cartridge of the present invention.

In accordance with the present invention, a method for repairing and refurbishing catalytic heaters broadly comprises the steps of removing a face frame and a face screen from a heater frame of a heater to be refurbished, removing catalyst material from an interior portion of the heater, providing a catalyst cartridge having a layer of catalyst material, and securing the cartridge to the heater frame.

A replacement catalyst cartridge used in the method of the present invention comprises a frame, an upper screen joined to the frame, a lower screen joined to the frame, and a layer of catalyst material positioned between the upper and lower screens.

Other details of the repair method and the replacement catalyst cartridge of the present invention, as well as other objects and advantages attendant thereto, are set forth in the following detailed description and the accompanying drawings wherein like reference numerals depict like elements.

### BRIEF DESCRIPTION OF THE DRAWINGS

FIG. 1 is a sectional view of a typical catalytic heater to be refurbished;

FIG. 2 is a top view of the catalytic heater of FIG. 1 stripped and ready for refurbishment;

FIG. 3 is a side view of the catalytic heater of FIG. 1;

FIG. 4 illustrates a face frame secured to a heater body;

FIG. 5 illustrates one embodiment of a replacement catalyst cartridge in accordance with the present invention; and

FIG. 6 is a sectional view of an alternative embodiment of a replacement catalyst cartridge in accordance with the present invention.

### DETAILED DESCRIPTION OF THE PREFERRED EMBODIMENT(S)

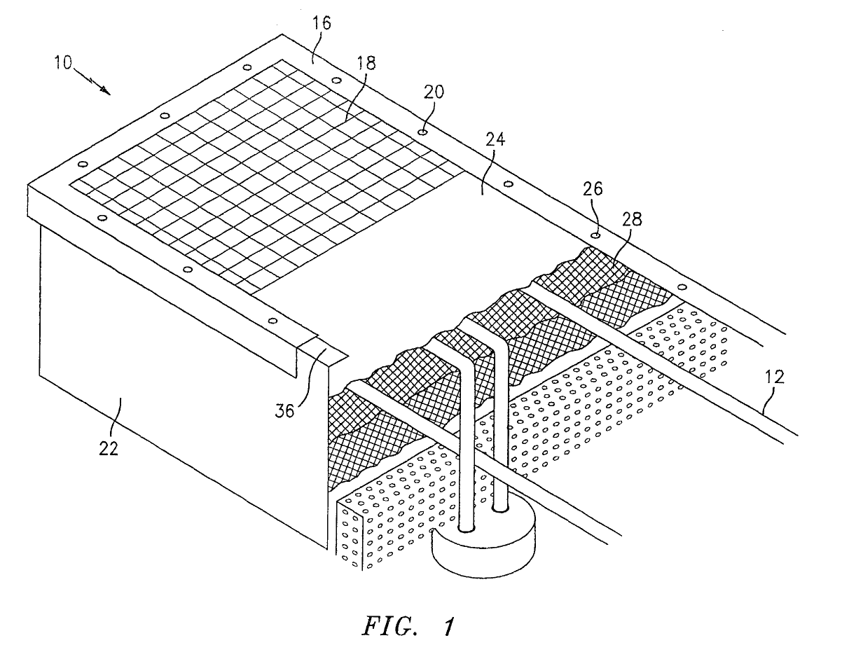

As previously mentioned, it becomes necessary to periodically replace the active catalyst layer in a catalytic heater to improve the performance of the heater. In accordance with the refurbishment method of the present invention, a catalytic heater 10, such as that shown in FIGS. 1-4, is preferably first removed from an oven (not shown) for initial retro-fit. While it is preferred to remove the heater 10 from the oven, this may not be necessary for all retro-fit repairs and refurbishments. Before removing the heater 10 from its oven, heater locations and plumbing connections should be mapped and marked. Lack of attention to this may delay re-installation of the refurbished heater. After removal from the oven, the heater 10 should be stripped of any wiring and plumbing connections.

After removing all wiring and jumpers from the electrical junction box, the pre-heat elements 12 in the heater 10 should be checked for continuity and ohms. Any suitable testing device known in the art may be used to check the continuity and ohms. Following this, the orifice 14 for supplying gas to the heater 10 is removed from the heater by tipping the catalytic heater 10 on the side and removing it. The orifice 14 may be removed using any suitable tool known in the art, such as a ¼″ socket driver. Compressed air is then blown in the orifice 14 to make sure the orifice is free of any debris. Preferably, a wand (not shown) is used to blow the compressed air into the orifice 14. When a wand is used, it should be waved back and forth across the orifice 14. The orifice 14 may be confirmed as being clean by holding it up to the light. After cleaning has been completed, the orifice 14 is replaced using any suitable tool known in the art.

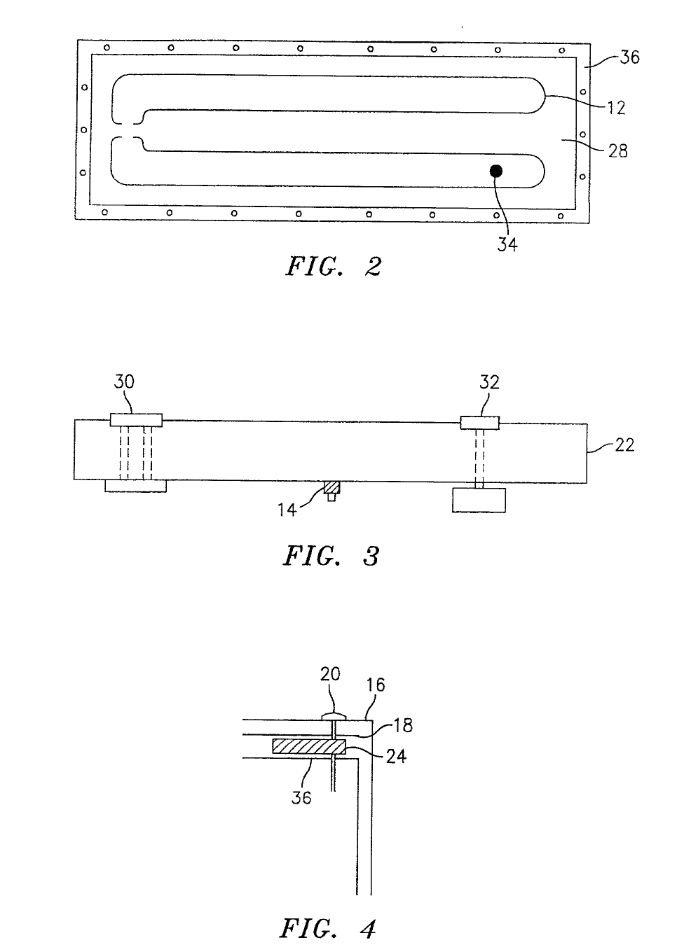

As can be seen from FIG. 2, a typical catalytic heater 10 has a face frame 16 and a face screen 18 surrounded by the face frame 16. A plurality of fastening elements 20, such as rivets, are typically used to secure the face frame 16 to a lip 36 of a heater frame or housing 22 as shown in FIG. 4. The fastening elements 20 are removed, such as by drilling the fastening elements 20 out using a ⅛″ steel drill bit, so that the face frame 16 and the face screen 18 may be removed from the heater frame 22. After the fastening elements 20 have been removed, the face frame 16 and the face screen 18 may be removed, if not easily lifted away from the heater body, using a suitable tool, such as a putty knife.

After the face frame 16 and the screen 18 have been removed, the catalyst material 24 within the heater 10 is exposed. The catalyst material 24 is peeled back, preferably rolling the material 24 from one end, and removed, thus exposing pre-heat elements 12 sitting on top of an insulating layer 28. The catalyst material 24, if desired, may be set aside for potential use later. Depending upon the thickness, or settling of existing insulating material with respect to its depth from the heater lip, just the catalyst can be removed, leaving behind supporting insulating layer.

Every hole 26 in the heater lip 36 is then cleaned and any fastening element fragments caused by the fastening element removal are cleaned out. A cutting wheel/grinder and hole punch may be used to perform this step. If necessary, fastening element bodies may be pulled from the underside of the lip 36 using a pair of pliers. Air is then gently blown across the heater face to remove all dust and debris.

The heater 10 should have a first piece 30 of heat insulation lying over the point where the pre-heat elements 12 terminate in the heater and a second piece 32 of heat insulation over the thermoswitch 34 to protect the insulation piece above it. If these insulation pieces are missing, new ones may be cut from the backing of the old catalyst layer by removing or peeling off the outer layer of used catalyst material to create a relatively clean piece of insulating material.

The heater 10 should then be inspected to determine whether it is necessary to build up the insulating layer in the heater 10 to be even with the lip 36 of the heater frame 22. If this is necessary, an additional layer of insulating material may be placed within the interior of the heater frame 22.

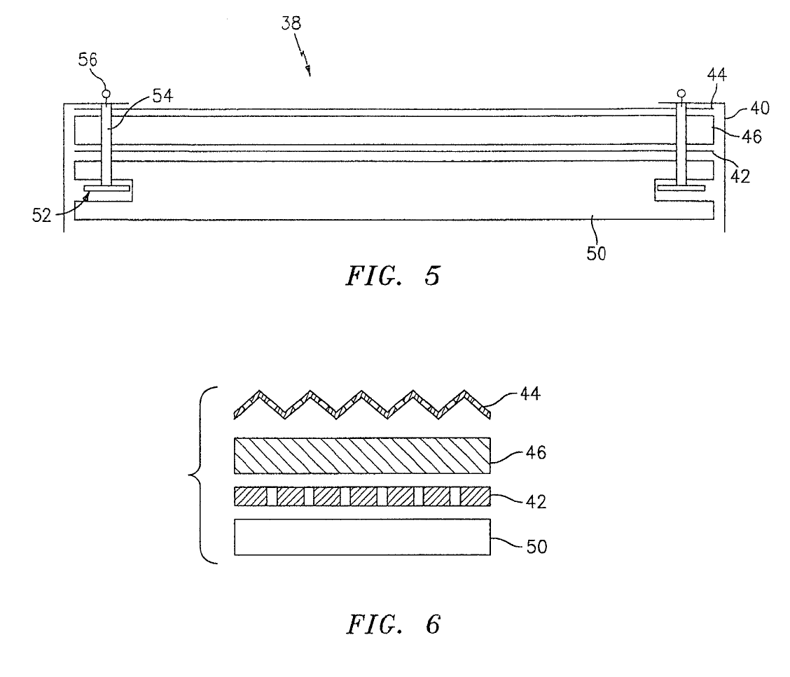

Referring now to FIG. 5, a catalyst cartridge 38 is then used to replace the catalytic material. The cartridge 38 comprises a frame 40 having a shape which corresponds to the shape of the heater frame or housing 22. The cartridge 38 has a bottom screen 42 and an upper screen 44 joined to the frame 40. A layer of catalytic material 46 is positioned between the upper and bottom screens 44 and 42 respectively. The catalytic material 46 may comprise a layer of any suitable catalytic material known in the art such as a layer of platinum, rhodium, or palladium. The upper screen 44 may be planar as shown in FIG. 5 or have a three dimensional corrugated configuration as shown in FIG. 6. The use of a three dimensional corrugated screen is extremely beneficial in that it allows an increase in the amount of catalyst surface area relative to the dimensional size of the heater, thus allowing an increase in the heat output.

The replacement cartridge 38 also has a layer of high temperature insulating material 50 which is split at locations 52 to accommodate a plurality of flat head screw barrels 54. The barrels 54 receive screws 56 to secure the insulating material 50 to the cartridge 38. By using such an arrangement, the insulating material 50 is pulled up, thus allowing the lower portion of the insulating material 50 to rest on heater lip 36 to form a gastight seal. The replacement cartridge 38 may be attached to the heater 10 by any suitable joining means resulting in a consistent downward force on the cartridge 38. The joining means may be spring clips, carriage bolts, flexible hose clamps, screw, rivets, or the like.

Prior to re-installation, the refurbished catalytic heater 10 may be flame tested to determine whether there is an even gas flow exiting the heater. Further, a source of flame, such as a torch, may be passed directly over each fastening element and along the outside edge of the heater 10 to make sure there are no leaks. Any leaking fastening elements should be replaced.

The wiring and plumbing may then be reinstalled and the heater 10 may be replaced within the oven.

One of the advantages of the present invention is that the replacement catalyst cartridge 38 itself can be easily replaced when the catalyst has outlived its useful life without removing the heater 10 from its oven. This can be done by unscrewing or unhooking the fastener arrangement, removing the old catalyst cartridge 38, and inserting a new catalyst cartridge 38.

The use of the replaceable catalytic cartridge 38 in the repair method of the present invention allows companies to simply replace the active catalyst layer on existing heaters with a pre-fabricated catalytic face cartridge and make the heaters like new. In some cases, the catalytic heaters do not have to be unwired, or un-plumbed, or even removed from the oven. The catalyst cartridge forms a gas tight seal over existing flanges and can easily be secured to the heater.

It is apparent that there has been provided in accordance with the present invention a method for repairing catalytic heaters and a replacement cartridge therefore which fully satisfies the objects, means and advantages set forth hereinbefore. While the present invention has been described in the context of specific embodiments thereof, other alternatives, modifications, and variations will become apparent to those skilled in the art having read the foregoing description. Accordingly, it is intended to embrace those alternatives, modifications, and variations which fall within the broad scope of the appended claims.

What is claimed is:

1. A method for repairing and refurbishing catalytic heaters comprising the steps of:
removing a face frame and a face screen from a heater frame of a heater to be refurbished;
removing catalyst material from an interior portion of the heater;
providing a catalyst cartridge having a layer of catalyst material; and
securing said cartridge to said heater frame.

2. The method according to claim 1, wherein said catalyst cartridge providing step comprises providing a catalyst cartridge having said layer of catalyst material sandwiched between an upper screen and a lower screen.

3. The method according to claim 1, further comprising removing all wiring and jumpers from electrical junction box and check pre-heat elements for continuity and ohms prior to said face frame and face screen removal step.

4. The method according to claim 1, further comprising removing and cleaning an orifice connected to said heater frame and reinstalling said orifice.

5. The method according to claim 1, further comprising cleaning all holes in a heater lip following removal of said catalyst layer.

6. The method according to claim 1, further comprising replacing insulation material over a point where pre-heat elements terminate in a heater and over the thermoswitch.

7. A replacement catalyst cartridge to be used in the refurbishment of catalytic heaters comprising a frame, an upper screen joined to said frame, a lower screen joined to the frame, and a layer of catalyst material positioned between said upper screen and said lower screen.

8. A replacement catalyst cartridge according to claim 7, wherein both said upper screen and said lower screen are planar.

9. A replacement catalyst cartridge according to claim 7, wherein said upper screen is corrugated and said lower screen is planar.

10. A replacement catalyst cartridge according to claim 7, further comprising a layer of insulation material positioned beneath the lower screen.

11. A replacement catalyst cartridge according to claim 10, further comprising a plurality of barrel heads having flat heads and a plurality of screws for joining said layer of insulation material to said cartridge.

12. A replacement catalyst cartridge according to claim 11, further comprising said layer of insulation material having split locations for receiving said flat heads of said barrel heads.

13. A refurbished catalytic heater having a frame with a peripheral lip and a replacement catalyst cartridge secured thereto, said replacement catalyst cartridge having a layer of insulation material which forms a gas tight seal with said peripheral lip.

14. A refurbished catalytic heater according to claim 13, wherein said replacement catalyst cartridge further comprises an upper screen, a lower screen, and a layer of catalyst material between said upper and lower screens.

15. A refurbished catalytic heater according to claim 14, wherein both said upper screen and said lower screen are planar.

16. A refurbished catalytic heater according to claim 14, wherein said upper screen is corrugated and said lower screen is planar.

17. A refurbished catalytic heater according to claim 13, wherein said replacement catalyst cartridge further has a peripheral frame and a plurality of screws and flat head barrels for securing said layer of insulation material to said peripheral frame.

18. A refurbished catalytic heater according to claim 17, wherein said layer of insulation material has split ends for receiving flat head portions of said flat head barrels.
